(19) United States
(12) Patent Application Publication
(10) Pub. No.: US 2014/0260321 A1
(43) Pub. Date: Sep. 18, 2014

(54) GAS TURBINE ENGINE STATIC STRUCTURE JOINT WITH UNDERCUTS

(71) Applicant: United Technologies Corporation, Hartford, CT (US)

(72) Inventors: James L. McClellan, IV, Kennebunk, ME (US); Gary L. Grogg, South Berwick, ME (US); Garth J. Vdoviak, JR., North Berwick, ME (US)

(73) Assignee: United Technologies Corporation, Hartford, CT (US)

(21) Appl. No.: 14/208,255

(22) Filed: Mar. 13, 2014

Related U.S. Application Data
(60) Provisional application No. 61/787,154, filed on Mar. 15, 2013.

(51) Int. Cl. F02C 7/20

(52) U.S. Cl. CPC F02C 7/20
USPC 60/796

(57) ABSTRACT

A gas turbine engine static structure has a joint that includes at least two flanges. The first flange includes a face extending axially proud between radially spaced apart undercuts. The second flange abuts the face. Fasteners secure the flanges to one another through the face.

### CROSS REFERENCE TO RELATED APPLICATION

This application claims priority to U.S. Provisional Application No. 61/787,154 filed on Mar. 15, 2013.

### BACKGROUND

This disclosure relates to a gas turbine engine, and more particularly, to engine static structure fastened joints.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

Gas turbine engines typically include numerous bolted flange joints to connect components to one another and facilitate assembly and disassembly of the engine. Once such joint has been provided through a ring gear joint for an engine with a geared architecture. The ring gear joint included first and second ring gear halves provided between forward and aft gutters that are arranged radially outwardly of the ring gear halves. This four-flange joint is secured by multiple circumferentially spaced fasteners. Each of the ring gear flanges include axial and radial surfaces joined to one another at a right angle. An undercut is provided at the intersection of the axial and radial surfaces and is recessed relative to each of these surfaces to provide stress relief.

### SUMMARY

In one exemplary embodiment, a gas turbine engine static structure has a joint having at least two flanges including first and second flanges. The first flange includes a face extending axially proud between radially spaced apart undercuts. The second flange abuts the face. Fasteners secure the flanges to one another through the face.

In a further embodiment of the above, the joint includes a third flange. The second flange is arranged axially between the first and third flanges. Fasteners secure the first, second and third flanges to one another at the joint.

In a further embodiment of any of the above, the second and third flanges separately contact the first flange radially.

In a further embodiment of any of the above, the second flange is a turbine exhaust case, and the first and third flanges correspond to a bearing support flange providing a bearing compartment.

In a further embodiment of any of the above, the first and second bearing supports respectively providing the first and third flanges. The first and second bearings are respectively mounted to the first and second bearing supports.

In a further embodiment of any of the above, the fasteners are provided by bolts and nuts.

In a further embodiment of any of the above, the undercuts provide a radial length of flange with uniform axial thickness.

In a further embodiment of any of the above, one of the first and second flanges includes an annular recess. The other of the first and second flanges includes a protrusion received in the annular recess. A seal is provided between the annular recess and the protrusion.

In a further embodiment of any of the above, the first flange provides a shoulder and the second flange provides an edge mating with the shoulder. The shoulder and the edge are arranged radially outward of the seal.

In a further embodiment of any of the above, the first undercut is provided by the shoulder, and the second undercut is provided by the protrusion.

In a further embodiment of any of the above, the first undercut includes a first radial surface and a first axial surface that are transverse to one another. The first radial surface is adjacent to the face. The first axial surface provides the shoulder.

In a further embodiment of any of the above, the second undercut includes a second radial surface and a second axial surface that are transverse to one another. The second radial surface is adjacent to the face. The second axial surface provides the protrusion.

In another exemplary embodiment, a gas turbine engine includes a combustor that is in fluid communication with the compressor section. A turbine section has a turbine exhaust case that provides a turbine exhaust case flange arranged at a joint. A bearing support flange is secured to the joint by fasteners. One of the turbine exhaust case flange and the bearing support flange having a face extending axially proud between opposite, adjacent first and second radially spaced apart undercuts. The other of the turbine exhaust case flange and the bearing support flange are secured to the face. The fasteners extend through the face.

In a further embodiment of any of the above, the bearing support flange includes first and second flanges. The turbine exhaust case flange is arranged axially between the first and second flanges.

In a further embodiment of any of the above, the turbine section includes a high pressure turbine arranged upstream from a low pressure turbine. The low pressure turbine is mounted on a spool supported by first and second bearings mounted to the bearing support flange.

In a further embodiment of any of the above, one of the first and second flanges includes an annular recess. The other of the first and second flanges includes a protrusion received in the annular recess. A seal is provided between the annular recess and the protrusion.

In a further embodiment of any of the above, the first flange provides a shoulder and the second flange provides an edge mating with the shoulder. The shoulder and the edge are arranged radially outward of the seal.

In a further embodiment of any of the above, the first undercut is provided by the shoulder. The second undercut is provided by the protrusion.

In a further embodiment of any of the above, the first undercut includes a first radial surface and a first axial surface that are transverse to one another. The first radial surface is adjacent to the face. The first axial surface provides the shoulder.

In a further embodiment of any of the above, the second undercut includes a second radial surface and a second axial surface that are transverse to one another. The second radial surface is adjacent to the face. The second axial surface provides the protrusion.

### BRIEF DESCRIPTION OF THE DRAWINGS

The disclosure can be further understood by reference to the following detailed description when considered in connection with the accompanying drawings wherein:

FIG. 1 schematically illustrates a gas turbine engine embodiment.

FIG. 2 is an enlarged cross-sectional view of an engine static structure joint.

FIG. 3 is an enlarged view of the joint shown in FIG. 2.

FIG. 4 is an enlarged view of a joint according to the disclosure, using two flanges.

### DETAILED DESCRIPTION

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis X relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis X.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 57 of the engine static structure 36 is arranged generally between the high pressure turbine 54 and the low pressure turbine 46. The mid-turbine frame 57 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 57 includes vanes 59, which are in the core airflow path and function as an inlet guide vane for the low pressure turbine 46. Utilizing the vane 59 of the mid-turbine frame 57 as the inlet guide vane for low pressure turbine 46 decreases the length of the low pressure turbine 46 without increasing the axial length of the mid-turbine frame 57. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/518.7) 0.5]. The “Low corrected fan tip speed”, as disclosed herein according to one non-limiting embodiment, is less than about 1150 ft/second.

Referring to FIG. 2, a turbine exhaust case 60 of the inner structure 36 is shown in more detail. The turbine exhaust case 60 supports first and second axially spaced bearings 64, 66 within a bearing compartment 62. A bearing support flange 70 is secured to a turbine exhaust case flange 76 of the turbine exhaust case 60 at a joint 68. In the example, the bearing support flange 70 is provided by first and second flanges 72, 74, which are respectively provided by first and second bearing supports 172, 174 to which the first and second bearings 64, 66 are secured.

The turbine exhaust case flange 76 and the first and second flanges 72, 74 are angular in shape and secured to one another by circumferentially spaced fasteners 78. As best shown in FIG. 3, the fastener 78 extends through first, second and third holes 79a, 79b, 79c in the first and second flanges 72, 74 and the exhaust turbine exhaust case flange 76. Each fastener 78 includes a bolt 80, first and second washers 82, 84 and a nut 86.

Returning to FIG. 2, an air seal 88 is provided within the bearing compartment 62 to prevent fluid from the low pressure turbine 46 from entering the bearing compartment. A heat shield 89 may be provided between the low pressure turbine 46 and the bearing compartment 62. In the example, the heat shield 89 is supported by the joint 68.

With reference to FIG. 3, the first flange 72 includes an annular protrusion 94 that mates with an annular recess 92 of the second flange 74 to provide a first pilot interface. An annular seal 90 is provided between the first and second flanges 72, 74 to seal the bearing compartment 62.

The first flange 72 provides a shoulder 96 arranged radially outward of the annular seal 90. An edge 98 of the turbine exhaust case flange 76 mates with the shoulder 96 to provide a second pilot interface. The annular recess and protrusion 92, 94 and the shoulder 96 and edge 98 radially align the first and second flanges 72, 74 and the turbine exhaust case flange 76 with respect to one another.

The joint 68 experiences stress during engine operation in the region provided radially inward and outward of the bolt circle provided by flanges 78 at the first and second pilot interfaces. These stresses create tension and bending forces on a face 100 of the first flange 72.

The face 100 is axially proud of opposite adjacent first and second radially spaced apart first and second undercuts 110, 112. The first undercut 110 is provided by first radially and axial surfaces 102, 104 that are at right angles with respect to one another and joined by a radius that is tangent to the first radially and axial surfaces 102, 104. The first axial surface 104 provides the shoulder 96, which has a uniform thickness at the first pilot interface.

The second undercut 112 is provided by second radial and axial surfaces 106, 108 that are at right angles with respect to one another and joined by a radius that is tangent to the second radially and axial surfaces 106, 108. The second axial surface 108 is provided by the protrusion 94, which has a uniform thickness at the second pilot interface leading up to the seal 90.

The first and second undercuts 110, 112 and their relatively small radii isolates the contacting bolt faces of the joint flanges from some of the bending and resultant stresses. The uniform thickness provided by the shoulder 96 and protrusion 94 enables the first flange 72 to be recut for service or repair without affecting the face 100.

Referring to FIG. 4, it should be understood that a joint 168 according to the disclosure need only have at least two flanges 172, 176. The flange 176 provides a tight fit at the pilot interface 150 at one radial side of the joint 168, while a gap 152 is provided at the other radial side of the joint 168. The flange 176 abuts the face 200, which is proud of the adjacent undercuts 210, 212.

Although an example embodiment has been disclosed, a worker of ordinary skill in this art would recognize that certain modifications would come within the scope of the claims. For that reason, the following claims should be studied to determine their true scope and content.

What is claimed is:

1. A gas turbine engine static structure comprising:
a joint having at least two flanges including first and second flanges, the first flange including a face extending axially proud between radially spaced apart undercuts, the second flange abutting the face, and fasteners extending through the face.

2. The gas turbine engine static structure according to claim 1, wherein the joint includes a third flange, the second flange arranged axially between the first and third flanges, fasteners securing the first, second and third flanges to one another at the joint.

3. The gas turbine engine static structure according to claim 2, wherein the second and third flanges separately contact the first flange radially.

4. The gas turbine engine static structure according to claim 3, wherein the second flange is a turbine exhaust case, and the first and third flanges correspond to a bearing support flange providing a bearing compartment.

5. The gas turbine engine static structure according to claim 3, comprising first and second bearing supports respectively providing the first and third flanges, and first and second bearings respectively mounted to the first and second bearing supports.

6. The gas turbine engine static structure according to claim 1, wherein the fasteners are provided by bolts and nuts.

7. The gas turbine engine static structure according to claim 1, wherein the undercuts provide a radial length of flange with uniform axial thickness.

8. The gas turbine engine static structure according to claim 2, wherein one of the first and second flanges includes an annular recess, the other of the first and second flanges includes a protrusion received in the annular recess, and a seal provided between the annular recess and the protrusion.

9. The gas turbine engine static structure according to claim 8, wherein the first flange provides a shoulder and the second flange provides an edge mating with the shoulder, the shoulder and the edge arranged radially outward of the seal.

10. The gas turbine engine static structure according to claim 9, wherein the first undercut is provided by the shoulder, and the second undercut is provided by the protrusion.

11. The gas turbine engine static structure according to claim 9, wherein the first undercut includes a first radial surface and a first axial surface that are transverse to one another, the first radial surface adjacent to the face, and the first axial surface providing the shoulder.

12. The gas turbine engine static structure according to claim 8, wherein the second undercut includes a second radial surface and a second axial surface that are transverse to one another, the second radial surface adjacent to the face, and the second axial surface providing the protrusion.

13. A gas turbine engine comprising:
a compressor section;
a combustor in fluid communication with the compressor section; and
a turbine section having a turbine exhaust case providing a turbine exhaust case flange arranged at a joint, a bearing support flange secured to the joint by fasteners, one of the turbine exhaust case flange and the bearing support flange having a face extending axially proud between opposite, adjacent first and second radially spaced apart undercuts, the other of the turbine exhaust case flange and the bearing support flange secured to the face, the fasteners extending through the face.

14. The gas turbine engine according to claim 13, wherein the bearing support flange includes first and second flanges, the turbine exhaust case flange arranged axially between the first and second flanges.

15. The gas turbine engine according to claim 14, the turbine section includes a high pressure turbine arranged upstream from a low pressure turbine, the low pressure turbine mounted on a spool supported by first and second bearings mounted to the bearing support flange.

16. The gas turbine engine according to claim 14, wherein one of the first and second flanges includes an annular recess, the other of the first and second flanges includes a protrusion received in the annular recess, and a seal provided between the annular recess and the protrusion.

17. The gas turbine engine according to claim 16, wherein the first flange provides a shoulder and the second flange provides an edge mating with the shoulder, the shoulder and the edge arranged radially outward of the seal.

18. The gas turbine engine according to claim 17, wherein the first undercut is provided by the shoulder, and the second undercut is provided by the protrusion.

19. The gas turbine engine according to claim 17, wherein the first undercut includes a first radial surface and a first axial surface that are transverse to one another, the first radial surface adjacent to the face, and the first axial surface providing the shoulder.

20. The gas turbine engine according to claim 16, wherein the second undercut includes a second radial surface and a second axial surface that are transverse to one another, the second radial surface adjacent to the face, and the second axial surface providing the protrusion.
